(19) United States
(12) Patent Application Publication
(10) Pub. No.: US 2024/0103633 A1
(43) Pub. Date: Mar. 28, 2024

(54) HOLD GESTURE RECOGNITION USING MACHINE LEARNING

(71) Applicant: Apple Inc., Cupertino, CA (US)

(72) Inventors: Bongsoo Suh, San Jose, CA (US); Behrooz Shahsavari, Hayward, CA (US); Charles Maalouf, Seattle, WA (US); Hojjat Seyed Mousavi, San Jose, CA (US); Laurence Lindsey, Portland, OR (US); Shivam Kumar Gupta, Fremont, CA (US)

(21) Appl. No.: 18/370,837

(22) Filed: Sep. 20, 2023

Related U.S. Application Data
(60) Provisional application No. 63/409,618, filed on Sep. 23, 2022.

(51) Int. Cl. G06F 3/01; G06N 3/0464

(52) U.S. Cl. CPC G06F 3/017; G06N 3/0464

(57) ABSTRACT

Embodiments are disclosed for hold gesture recognition using machine learning (ML). In an embodiment, a method comprises: receiving sensor signals indicative of a hand gesture made by a user, the sensor data obtained from at least one sensor of a wearable device worn by the user; generating a first embedding of first features extracted from the sensor signals; predicting a first part of a hold gesture based on a first ML gesture classifier and the first embedding; generating a second embedding of second features extracted from the sensor signals; predicting a second part of the hold gesture based on a second ML gesture classifier and the second embedding; predicting a hold gesture based at least in part on outputs of the first and second ML gesture classifiers and a prediction policy; and performing an action on the wearable device or other device based on the predicted hold gesture.

### CROSS-REFERENCE TO RELATED APPLICATION

This application claims priority to U.S. Provisional Patent Application No. 63/409,618, filed Sep. 23, 2022, the entire contents of which are incorporated herein by reference.

### TECHNICAL FIELD

This disclosure relates generally to gesture recognition for navigating user interfaces or performing other actions on wearable devices.

### BACKGROUND

Wearable computers, such as a wrist-worn smartwatch, have grown in popularity and are being used for a variety of purposes, such as health monitoring and fitness applications. A user typically interacts with their smartwatch through a touch display and/or crown using hand/finger gestures, such as tap, swipe or pinch. These gestures however, require the user to have a free hand available to perform the gesture. There are many scenarios, however, where a free hand is not available, such as when the user is holding a baby or groceries or if the user is physically disabled.

### SUMMARY

Embodiments are disclosed for hold gesture recognition using machine learning.

In an embodiment, a method comprises: receiving sensor signals indicative of a hand gesture made by a user, the sensor signals obtained from at least one sensor of a wearable device worn by the user; generating a first embedding of first features extracted from the sensor signals; predicting a first part of a hold gesture based on a first ML gesture classifier and the first embedding; generating a second embedding of second features extracted from the sensor signals; predicting a second part of the hold gesture based on a second ML gesture classifier and the second embedding; predicting a hold gesture based at least in part on outputs of the first and second ML gesture classifiers and a prediction policy; and performing an action on the wearable device or other device based on the predicted hold gesture.

In some embodiments, the sensor signals include a bio signal and at least one motion signal.

In some embodiments, the first and second ML gesture classifiers are run concurrently in parallel.

In some embodiments, the prediction policy comprises: determining, with the at least one processor, whether the first ML gesture classifier predicts the first part of the hold gesture based on a first set of prediction probabilities over a gesture time window; determining whether the second ML gesture classifier predicts the second part of the hold gesture based on a second set of prediction probabilities over the gesture time window; aggregating the first and second sets of probabilities; determining whether a pair of corresponding probabilities from the first and second sets of probabilities meets or exceeds a minimum threshold during the gesture time window; and in accordance with determining that corresponding probabilities from the first and second sets of probabilities meet or exceed the minimum threshold during the gesture time window, predicting the hold gesture.

In some embodiments, the first and second ML gesture classifiers are convolutional neural networks.

In some embodiments, the sensor signals are each filtered through a number of band-pass filters having adjacent and non-overlapping frequency bands.

In some embodiments, the first and second ML gesture classifiers are trained by dissecting the sensor signals into N second input buffers overlapping by a prediction frequency.

In some embodiments, the first and second ML gesture classifiers share a common network for generating the first and second embeddings.

In some embodiments, the first and second ML gesture classifiers have separate networks for generating the first and second embeddings, respectively.

In some embodiments, generating the first and second embeddings, further comprises: extracting, using at least one self-attention network, features from the sensor signals; concatenating the features into a data structure; performing multilayer convolution on contents of the data structure; and generating the first and second embeddings based on results of the multilayer convolution.

Particular embodiments described herein provide one or more of the following advantages. Detecting hold gestures allows more complex hand gestures to be detected by a wrist-worn device, thus increasing the number of actions that can be initiated by hand gestures on a wearable device (e.g., a smart watch).

### BRIEF DESCRIPTION OF THE DRAWINGS

FIG. 1A illustrates various types of hand gestures that can be used to navigate a user interface (UI) or perform other actions on a wearable device or other device, according to some embodiments.

FIG. 1B illustrates how hold gestures can be predicted from transitions in sensor data using machine learning (ML) models, according to some embodiments.

FIG. 2A is a block diagram of a system having two-stage ML gesture classifiers and a hold state policy model for predicting hand gestures, according to some embodiments.

FIG. 2B is a block diagram of multiple ML gesture classifiers and a fusion policy to predict different parts of hold gestures, according to some embodiments.

FIG. 3 is a block diagram of a ML gesture model for predicting hand gestures, according to some embodiments.

FIG. 4 illustrates a prediction policy for hand gestures, according to some embodiments.

FIG. 5 is a block diagram of a first system that includes two-stage ML hold gesture classifiers that share the same embedding extractor, but have two separate gesture classifiers, according to some embodiments.

FIG. 6 illustrates the prediction policy for the system shown in FIG. 5, according to some embodiments.

FIG. 7 illustrates a second system that includes two-stage ML hold gesture classifiers in a single ML model, where each classifier has its own embedding extractor, and where each classifier learns features specific to start or end transitions of hold gestures, according to some embodiments.

FIG. 8 illustrates a third system that is similar to the second system shown in FIG. 7, but uses two separate ML models, according to some embodiments.

FIG. 9 illustrates a fourth system that is similar to the third system shown in FIG. 8, but uses more than two ML models, according to some embodiments.

FIG. 10 is a flow diagram of a process of predicting hold gestures, according to some embodiments.

FIG. 11 is block diagram of a system architecture for implementing the features and processes described in reference to FIGS. 1-10, according to some embodiments.

### DETAILED DESCRIPTION

The disclosed systems and methods utilize two or more two-stage hold gesture ML classifiers, and prediction policy based on a “hold state.” Some examples of hold gestures include “clinch and hold,” where the user closes her hand into a first and holds it for some time before opening her hand, and “pinch and hold,” where the use performs a pinch gesture with her fingers and holds it for some time and then releases her fingers.

A first ML gesture classifier is trained to detect and classify a first part of the hold gesture (e.g., hand closing) based on a first embedding of first features extracted from sensor data (e.g., bio signal, motion signals), and a second ML gesture classifier is trained to detect a second part of the hold gesture (e.g., hand opening) based on a second embedding of second features extracted from the sensor data. If the first ML gesture classifier detects a hold gesture (e.g., clinch and hold), then the system/method will change the hold state to TRUE. If the second ML classifier detects an end of the hold gesture, the system/method changes the hold state to FALSE.

In some embodiments, both ML gesture classifiers are run concurrently in-parallel. If the system/method is in the hold state, the system/method takes the result from the first ML gesture classifier. If the system/method is not in the hold state, the system/method takes the result from the second ML gesture classifier. After multiple predictions from the ML gesture classifiers are made in a gesture window, the class probabilities output by the first and second ML gesture classifiers are aggregated (e.g., aggregated into a single vector), and passed into a prediction policy stage to aggregate the prediction probabilities and finalize the gesture decision conditioned on the hold state. These operations are described in further detail below.

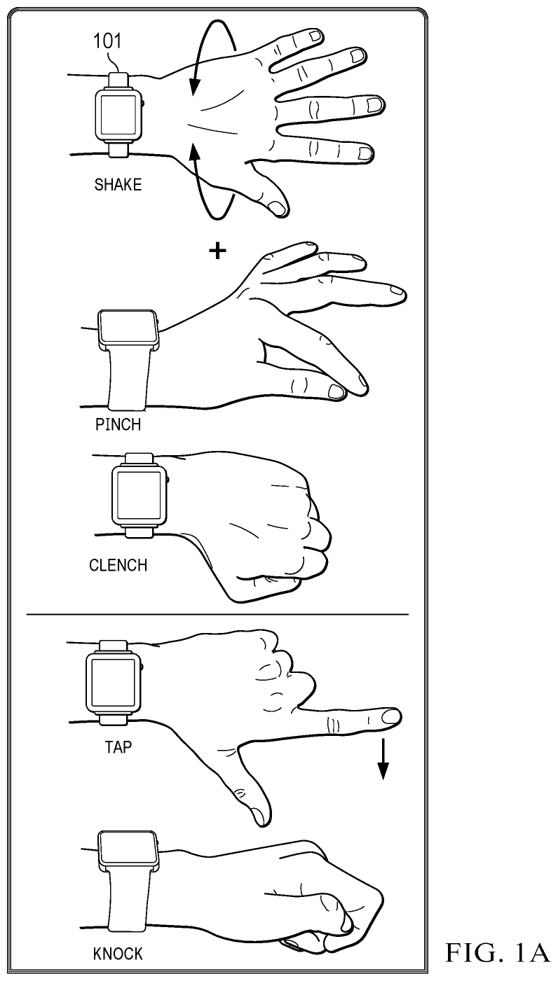

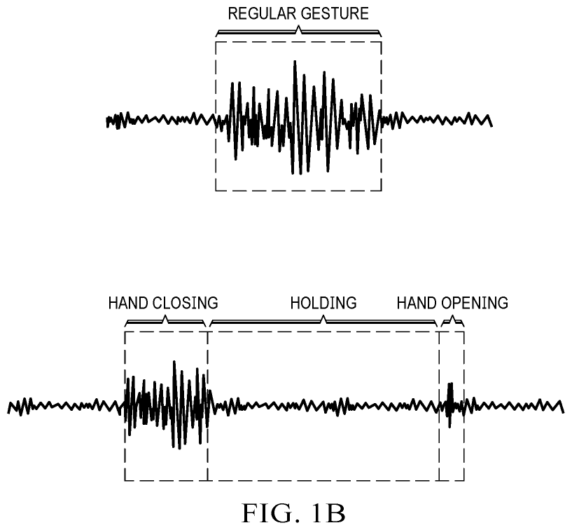

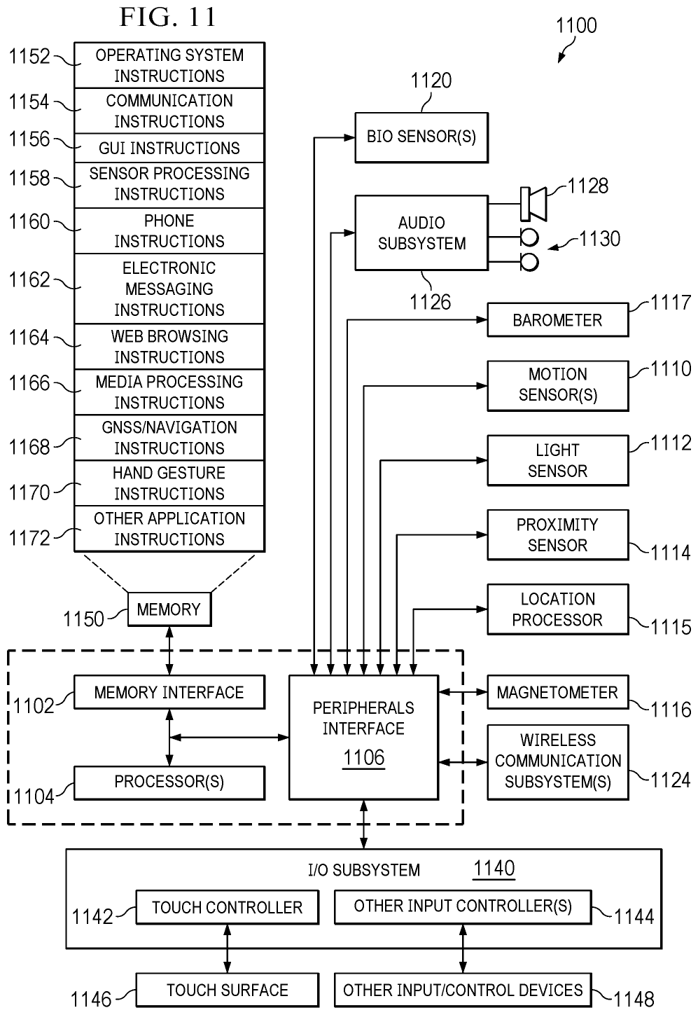

FIG. 1A illustrates various types of hand gestures that can be used to navigate a user interface (UI) or perform other actions on wearable device 101. The example hand gestures shown in FIG. 1A include but are not limited to: pinching the thumb and index finger together, clenching the hand into a fist, tapping one or more fingers on a surface and knocking a first on a surface. These hand gestures generate motion and/or forces that can be captured by the bio signal sensors and/or motion sensors of wearable device 101. An example system architecture that can be implemented by wearable device 101 is described in reference to FIG. 11. Although wearable device 101 is shown as a smartwatch attached to a user's wrist, in other applications the wearable device can be attached to other limbs or parts of limbs (e.g., to a user's arm or leg), or multiple wearable devices can be attached to multiple limbs.

In some embodiments, the bio signal sensor(s) is a PPG sensor configured to detect blood volume changes in a microvascular bed of tissue of a user (e.g., where the user is wearing the device on his/her body, such as his/her wrist). The PPG sensor may include one or more light-emitting diodes (LEDs) which emit light and a photodiode/photodetector (PD) which detects reflected light (e.g., light reflected from the wrist tissue). The bio signal sensor(s) are not limited to a PPG sensor, and may additionally or alternatively correspond to one or more of: an electroencephalogram (EEG) sensor, an electrocardiogram (ECG) sensor, an electromyogram (EMG) sensor, a mechanomyogram (MMG) sensor (e.g., piezo resistive sensor) for measuring muscle activity/contractions, an electrooculography (EOG) sensor, a galvanic skin response (GSR) sensor, a magnetoencephalogram (MEG) sensor and/or other suitable sensor(s) configured to measure bio signals.

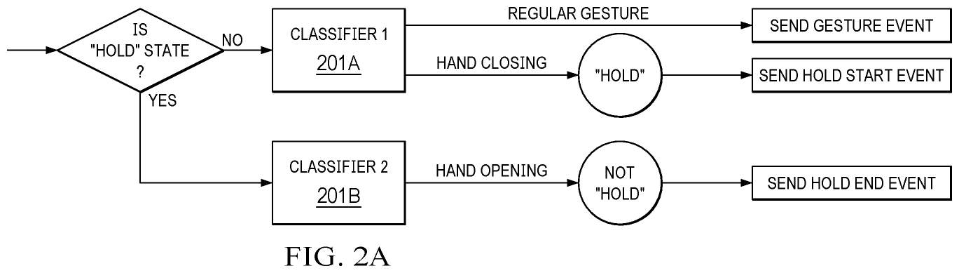

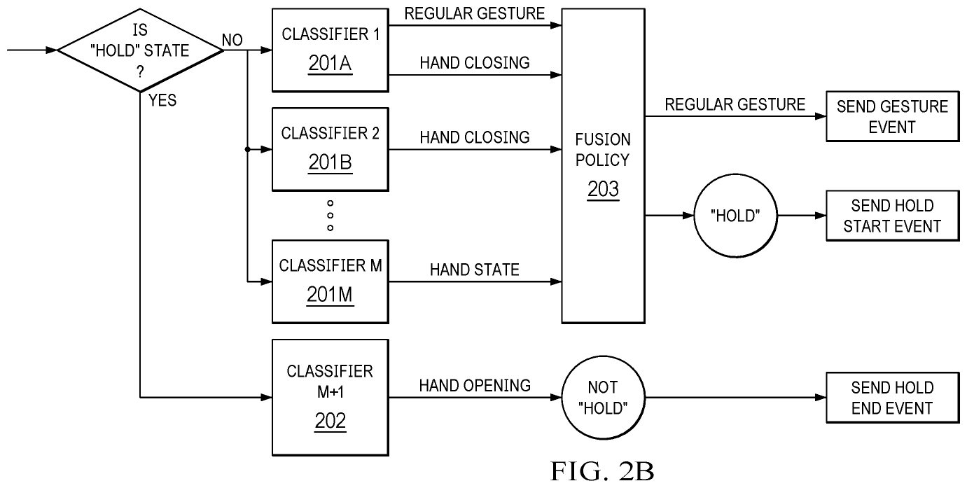

In some embodiments, wearable device 101 includes non-bio signal sensor(s) that include one or more motion sensors for detecting device motion. For example, the motion include but are not limited to accelerometers and angular rate sensors (e.g., gyroscopes) for detecting device acceleration and angular rates, respectively. As discussed further below with respect to FIGS. 2-11, wearable device 101 may be configured to predict hand gestures, and in particular hold gestures, based on sensor data provided by the bio signal sensor(s) and/or motion sensor(s).

FIG. 1B illustrates how hold gestures can be predicted from transitions in sensor data using machine learning (ML) models, according to some embodiments. As shown in FIG. 1B, for a non-hold hand gesture (e.g., clinch, pinch) there is a single gesture event captured in the sensor data that is indicative of a gesture. By contrast, a hold gesture has two gesture events that are captured in the sensor data: hand closing and hand opening. By training ML classifiers on training data comprising sensor data capturing hold gestures, the hold gestures can be predicted during inference.

FIG. 2A is a block diagram of system 200a having two-stage ML gesture classifiers and a hold state policy model for predicting hold gesture start/stop times, according to some embodiments. System 200a includes a first ML gesture classifier 201a (“Classifier 1”) and a second ML gesture classifier 201b (“Classifier 2”). Classifier 201a is trained to detect a particular gesture (e.g., clinch, pinch) and a hand closing gesture, and classifier 201b is trained to predict a hand opening gesture.

If system 200a is not in a hold state (hold=FALSE), and classifier 201a predicts a particular non-hold gesture (e.g., a clinch gesture), then system 200a sends a gesture event. Additionally, if classifier 201a predicts a hand closing gesture, the hold state of system 200a is set (hold=TRUE) and system 200a sends a hold start event. If the hold state is set (hold=TRUE), and ML classifier 201b detects a hand opening gesture, then the hold state is set to FALSE (hold=FALSE) and system 200a sends a hold end event.

FIG. 2B is a block diagram of system 200b that includes multiple ML gesture classifiers and a fusion policy to predict different parts of hold gestures, according to some embodiments. In this embodiment, M gesture classifiers 201a, 201c . . . 201M are trained to recognize different parts of hold gestures and classifier 202 (M+1 classifier) is trained to detect a hand opening gesture as in FIG. 2A. Fusion policy 203 combines the outputs of classifiers 201a . . . 201M to predict a hand gesture and the start of a hold event. System 200b allows for predicting hold gestures that have more than two parts.

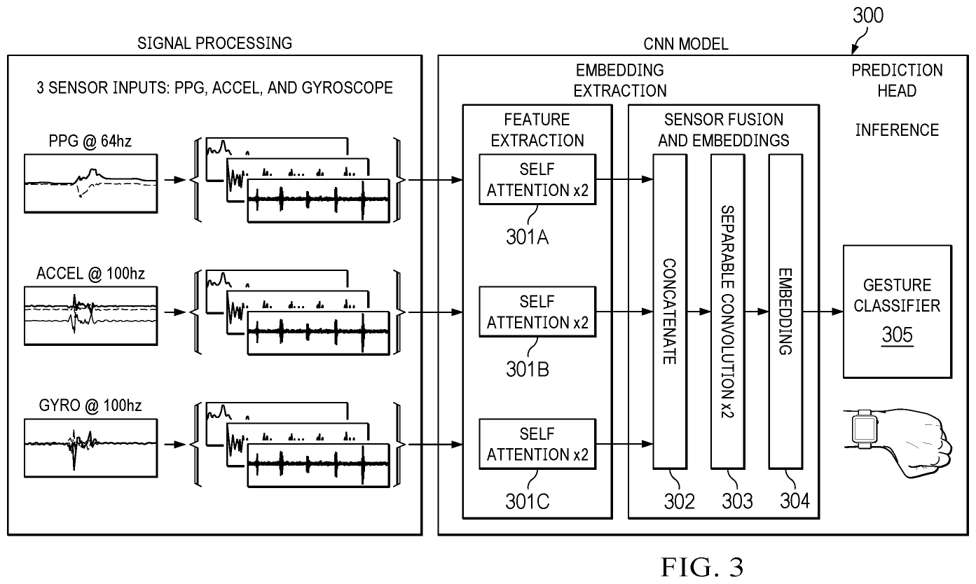

FIG. 3 is a block diagram of a ML model 300 for predicting hand gestures, according to some embodiments. In this example, the input sensor signals include at least one of PPG signals, accelerations (e.g., from am accelerometer embedded in wearable device 101) and rotation rates (e.g., from a gyroscope embedded in wearable device 101) captured by sensors embedded in wearable device 101. In some embodiments, each sensor signal goes through filters (e.g., three band-pass filters) of adjacent and exclusive frequency bands. For example, for PPG the band-pass filter is tuned to extract low frequency trends, heart rate information and high frequency motion artifacts. In some embodiments, the filter cutoffs can be learned as hyperparameters.

The filtered sensor signals are passed into ML model 300, which in this embodiment is a convolutional neural network (CNN) with input blocks processing each group of signals separately before fusing the signals together to learn cross-function correlations between the channels. In other embodiments, the CCN can be replaced by another suitable ML model including but not limited to a support vector machine (SVM), a k-nearest neighbors (KNN) model, a means and variance (MV) model or a deep belief model (DBM).

ML model 300 outputs gesture probabilities. In some embodiments, ML model 300 is based on the “EfficientNet” architecture described in Mingxing Tan and Quoc Le. 2019. EfficientNet: Rethinking Model Scaling for Convolutional Neural Networks. In International Conference on Machine Learning. PMLR, 6105-6114. In some embodiments, ML model 300 includes self-attention networks 301a-301c that each include a series of convolutional layers and normalization layers (e.g. batch normalization) that are trained to learn which sensor data is most important based on context. Accordingly, self-attention networks 301a-301c enhance or diminish the input features prior to prediction. In some embodiments, self-attention networks 310a-301c are repeated twice to extract more relevant features for the gesture classifier.

The outputs of self-attention networks 301a-301c are concatenated 302 into a data structure (e.g., a single vector) which is input into convolution layers 303 (e.g., two layers), which performs separable convolution on the data. The output of convolution layers 303 is input into embedding generator 304, which in some embodiments includes a max-pooling layer and a flattening layer that generates an embedding suitable for consumption by gesture classifier 305.

Gesture classifier 305 (e.g., a neural network) is trained to detect hand gestures based on the embedding input. In an embodiment, gesture classifiers 305 includes a stack of fully connected layers with a batch normalization layer and a dropout layer inserted between every two fully connected layers to improve model generalizability. The output of the final layers corresponds to the confidence (e.g., confidence score) of the gesture classes. In an embodiment, a cross-entropy loss function and Adam optimizer is used during training.

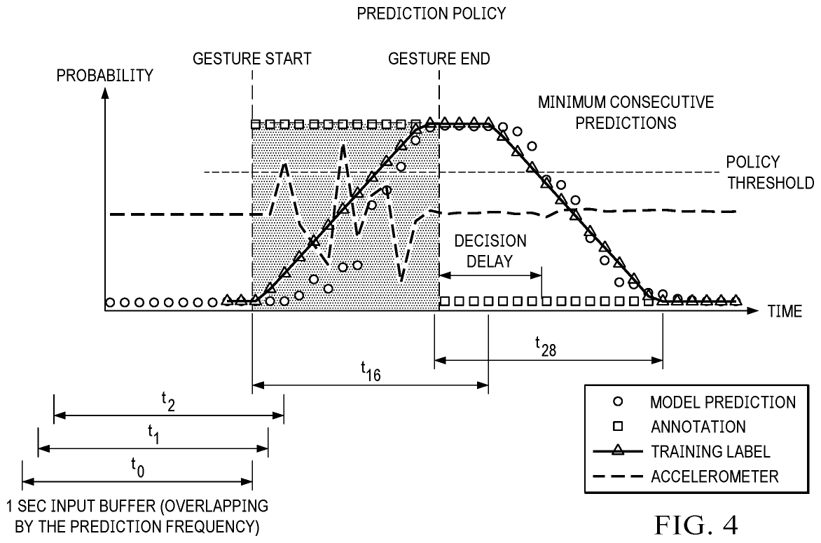

FIG. 4 illustrates a prediction policy for hold gestures, according to some embodiments. A multivariable graph is shown that plots model prediction, training labels, annotations and accelerometer sensor data. The vertical axis is probability (e.g., confidence score on predicted gesture label) and the horizontal axis is time. The shaded portion beginning with gesture start and ending with gesture end is hereinafter referred to as the gesture window. The gesture start and end times are generated as shown in FIG. 2A.

In some embodiments, the sensor signals are dissected into N second (e.g., 1 second) input buffers that are overlapping by the prediction frequency. At inference time, the network looks back by an N second window and predicts the gesture probability. In some embodiments, instead of directly using the gesture start and end annotations, the labels are smoothed by computing a portion of a sliding gesture window that intersects with the input buffers that store the samples of the sensor signals, and new training labels are generated. For example, at time to there is no intersection between the input buffer and the gesture window, so the ground truth probability is zero. At time t₁₆, the entire gesture window intersects with the input buffer, so the training label is assigned to 1. At time t₂₈ the ground truth probability is zero again.

In some embodiments, the prediction policy triggers a gesture event from a stream of model prediction probabilities, aggregates the incoming network predictions, and counts the number consecutive prediction of a same gesture class above a certain policy threshold. In some embodiments, the prediction policy triggers a gesture event if more than a minimum number of consecutive predictions above the threshold is observed. In some embodiments, Pareto optimal min-consecutive and policy threshold parameters are used to find minimum latency with a specified accuracy specification.

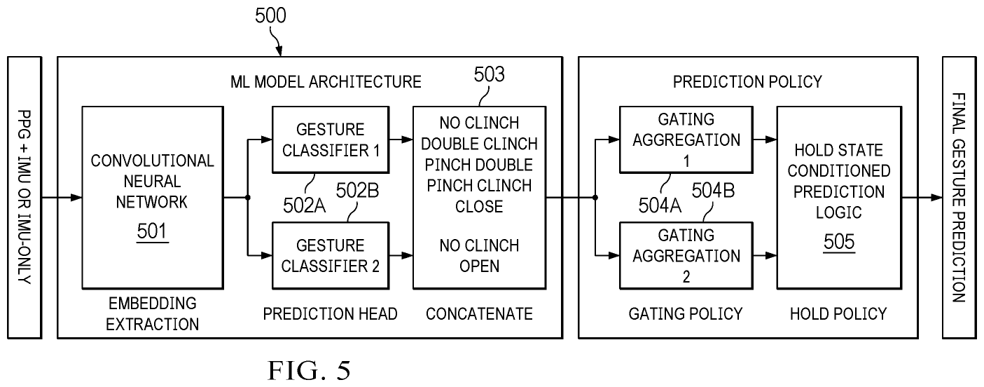

FIG. 5 is a block diagram of a first system 500 that includes two separate two-stage gesture classifiers in the prediction head, according to some embodiments. System 500 includes embedding extraction network 501, gesture classifier 502a, gesture classifier 502b, concatenator block 503, gating aggregator blocks 504a, 504b and hold state conditions prediction logic 505. System 500 is designed to predict a limited number of hold hand gestures, including no clinch, double clinch, pinch, double pinch, clinch close and no clinch open. More gestures, however, can be handled by adding more gesture classifiers to the prediction head.

In this embodiment, gesture classifiers 502a, 502b share the same embedding extraction network 501. Embedding extraction network 501 can learn both embedding representations (e.g., for hand closing and hand opening), which makes the computation efficient when deployed on a wearable device. In this example, gesture classifier 502a predicts a 6-dimensional probability vector and gesture classifier 502b predicts a two-dimensional probability vector. In this example, classifiers 502a, 502b are compiled by concatenation block 503 into a single 8-dimensional single-vector output probability.

In this embodiment, the prediction policy is implemented using two parallel gating aggregator blocks 504a, 504b and hold state conditioned prediction logic 505 to mitigate corner cases and output the final gesture prediction. Hold state conditioned prediction logic 505 takes the gesture events and compares their confidence scores. The final gesture prediction is output based on the hold state or other external inputs depending on, for example, a user interface (UI)/user experience (UX) state.

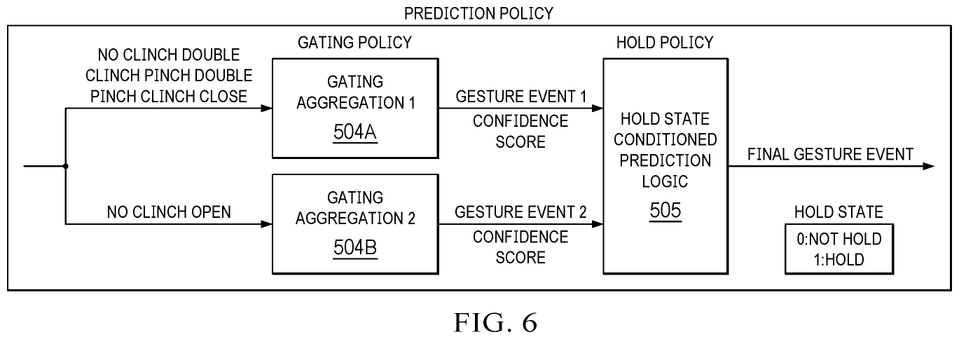

FIG. 6 illustrates the prediction policy for the system shown in FIG. 5, according to some embodiments. The gesture events output by classifiers 502a, 502b are routed into gating aggregators 504a, 504b. Gating aggregator 504a outputs a first gesture event and associated confidence score and gating aggregator 504b outputs a second gesture event and associated confidence score. The gesture events and confidence scores are input into hold state conditioned logic 505 which outputs a final gesture event. Logic 505 considers all possible and impossible cases that can be in the hold state, and avoids getting stuck in hold state=TRUE. In some embodiments, logic 505 can receive external inputs from the wearable device that provides UI/UX information. Logic 505 can be further illustrated by the following 4 example Cases.

Case 1: Gesture event 1 arrives only. If NOT in a hold state, send final gesture, and if the event is a clinch/pinch close, set the hold state to hold=TRUE. If hold=TRUE, and if the confidence score is below a confidence score threshold, ignore the event. If hold=TRUE and if the confidence score is over the confidence score threshold, based on, for example, UI/UX context and timeout, set hold=FALSE and send final gesture event (corner case).

Case 2: Gesture event 2 arrives only. If hold=FALSE, ignore event. If hold=TRUE, set hold=FALSE, send final open event.

Case 3: Both gesture event 1 and gesture event 2 arrive (corner case). Based on hold state condition and confidence scores, send the final event. If hold=FALSE and if the gesture event 1 confidence score is over the confidence score threshold, send the final event. If hold=FALSE, and if the gesture event 1 confidence score is over the confidence score threshold, follow Case 1. If the gesture event 1 confidence score is below the confidence score threshold, ignore the gesture event. If hold=TRURE, and if the gesture event 2 confidence score is over the confidence score threshold, follow Case 2. If hold=TRUE, and if the gesture event 1 confidence score is over the confidence score threshold, follow Case 1. If hold=TRUE and both the confidence scores for gesture event 1 and gesture event 2 are below the confidence score threshold, ignore the gesture events.

Case 4: Neither gesture 1 event nor gesture 2 event arrived. Perform UI/UX forced hold state termination or perform timeout forced hold state termination, and set hold=FALSE.

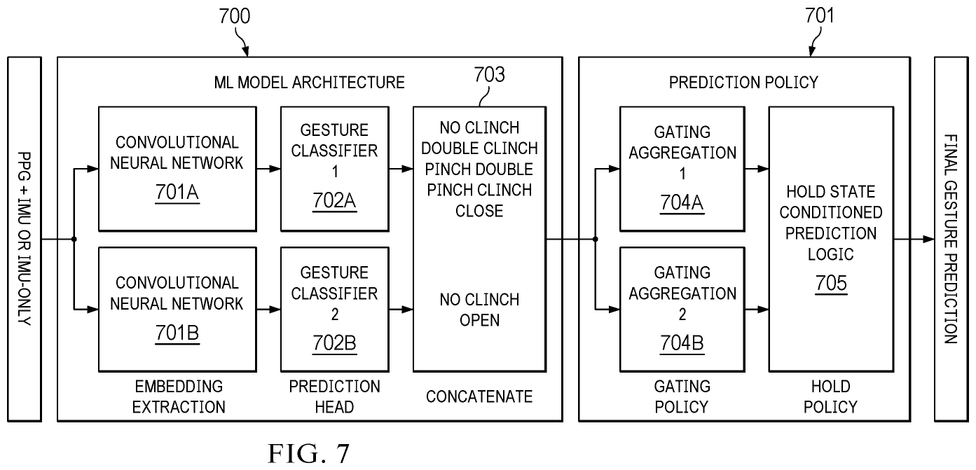

FIG. 7 illustrates a second system 700 that includes two-stage hold gesture classifiers in a single ML model, where each classifier has its own embedding extractor, and where each classifier learns features specific to start or end transitions of hold gestures, according to some embodiments. System 700 includes embedding extraction networks 701a, 701b, gesture classifiers 702a, 702b, concatenation block 703, gating aggregator blocks 704a, 704b and hold state conditioned prediction logic 705.

In this embodiment, gesture classifiers 702a, 702b are coupled to the outputs of embedding extraction networks 701a, 701b, respectively. Each embedding extractor 701a, 701b learns features specific to start or end transitions of hold gestures. This embodiment can have a higher performance accuracy than system 500, but requires more computation power. The architecture of system 700 has a similar architecture as system 500, where each path has its own prediction head, gesture classifier 702a predicts a 6-dimensional probability vector and gesture classifier 702b predicts a 2-dimensional probability vector. The predictions output by classifiers 702a, 702b are compiled into a single ML model 700 with a concatenated single probability vector output by concatenation block 703. The prediction policy is the same as for system 500 as described in reference to FIG. 6.

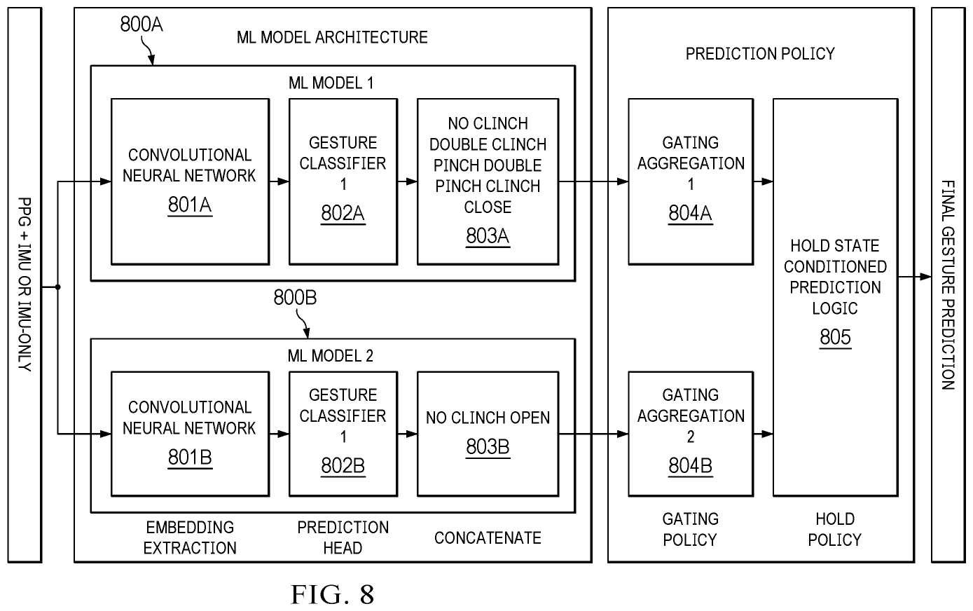

FIG. 8 illustrates a third system 800 that is similar to system 700 shown in FIG. 7, but uses two separate ML models 800a, 800b, according to some embodiments. ML model 800a has a similar architecture as ML model 700 with the difference being ML model 800a does not compile two-stage classifiers. More particularly, ML Model 800a includes extraction embedding network 801a. The output of embedding extraction network 801a is input into gesture classifier 802a. ML Model 800b includes embedding extraction network 801b. The output of embedding extraction network 801b is input into gesture classifier 802b. The predictions output by gesture classifiers 802a, 802b are input into concatenator blocks 803a, 803b, respectively. The outputs of concatenator blocks 803a, 803b are input gating aggregator blocks 804a, 804b, respectively. The outputs of gating aggregator blocks 804a, 804b are input into hold state conditioned prediction logic 805, which outputs the final gesture prediction.

In some embodiments, ML model 800a and ML model 800b are run in parallel, or either path can be run independent of the other, depending on the hold state set by the hold state conditioned logic 805. In some embodiments, running a single ML model is more efficient. Hold state conditioned prediction logic 805 can be modified if it only runs a single path, as there will be no case where both gesture events from gating aggregators 804a, 804b arrive.

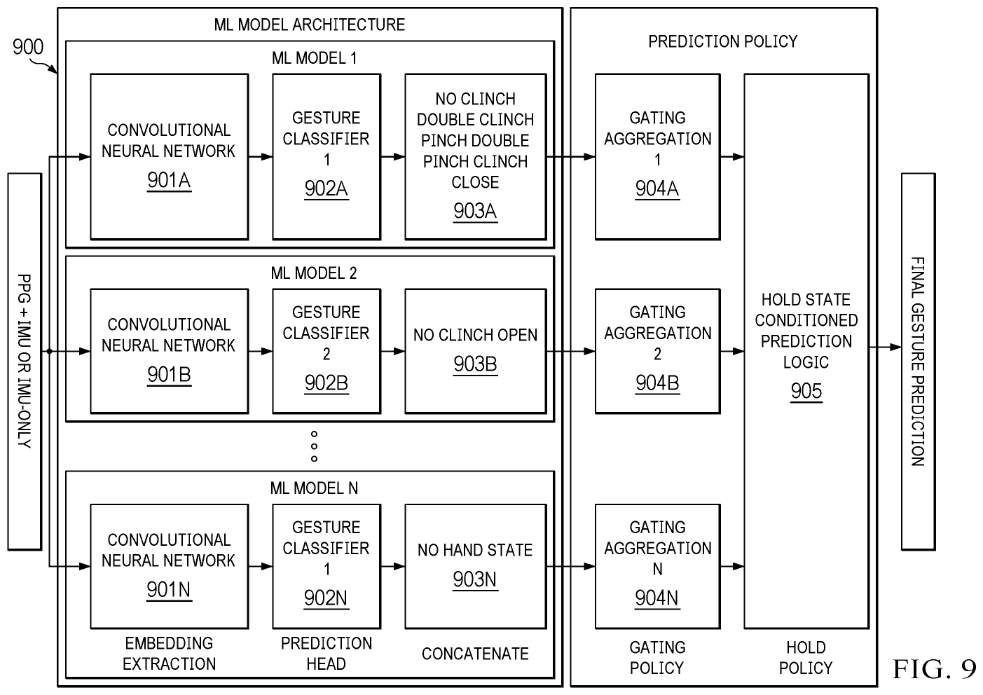

FIG. 9 illustrates a fourth hold gesture system 900 that is similar to the third system 800 shown in FIG. 8, but uses more than two ML models 901a, 901b . . . 901N and includes more than two parallel paths. A single path or set of ML models 901a, 901b . . . 901N can run in parallel, depending on the hold state set by hold state conditioned logic 905. By running a set of ML models in parallel, system 900 can improve gesture detection accuracy and speed. In some embodiments, hold state conditioned logic 905 determines which set of ML models 901a, 901b . . . 901N to run depending on the hold state and earlier confidence scores. The outputs of ML models 901a, 901b are input into concatenator blocks 903a, 903b . . . 903N, respectively. The outputs of concatenator blocks 903a, 903b . . . 903N are input into gating aggregator blocks 904a, 904b . . . 904N, respectively. The outputs of gating aggregator blocks 902a . . . 902N are input into hold state conditioned prediction logic 905, which outputs the predicted gesture.

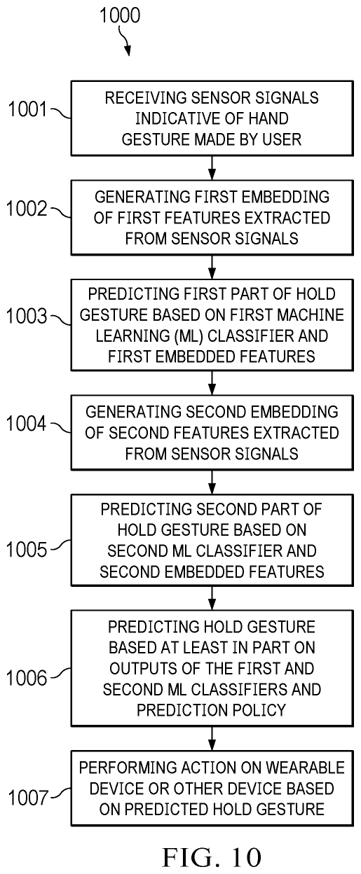

FIG. 10 is a flow diagram of process 1000 of detecting hold gestures using ML models, according to an embodiment. Process 1000 can be implemented using, for example, the system architecture described in reference to FIG. 11.

Process 1000 begins by receiving sensor signal(s) indicative of a hand gesture made by a user (1001), where the sensor signal(s) is obtained from at least one sensor of a wearable device worn on a wrist of the user; generating a first embedding of first features extracted from the sensor data (1002); predicting a first part of a hold gesture based on a first machine learning (ML) gesture classifier and the first embedding (1003); generating a second embedding of second features extracted from the sensor data (1004); predicting a second part of the hold gesture based on a second ML gesture classifier and the second embedding (1005); predicting a hold gesture based at least in part on outputs of the first and second ML gesture classifiers and a prediction policy (1006); and performing an action on the wearable device or other device based on the predicted hold gesture (1007). Each of these steps was previously discussed in reference to FIGS. 1-9.

FIG. 11 is block diagram of a system for implementing the features and processes described in reference to FIGS. 1-10. Architecture 1100 can include memory interface 1102, one or more hardware data processors, image processors and/or processors 1104 and peripherals interface 1106. Memory interface 1102, one or more processors 1104 and/or peripherals interface 1106 can be separate components or can be integrated in one or more integrated circuits. System architecture 1100 can be included in any suitable electronic device, including but not limited to: a smartwatch, smartphone, fitness band and any other device that can be attached, worn or held by a user.

Sensors, devices and subsystems can be coupled to peripherals interface 1106 to provide multiple functionalities. For example, one or more motion sensors 1110, light sensor 1112 and proximity sensor 1114 can be coupled to peripherals interface 1106 to facilitate motion sensing (e.g., acceleration, rotation rates), lighting and proximity functions of the wearable device. Location processor 1115 can be connected to peripherals interface 1106 to provide geo-positioning. In some implementations, location processor 1115 can be a GNSS receiver, such as the Global Positioning System (GPS) receiver. Electronic magnetometer 1116 (e.g., an integrated circuit chip) can also be connected to peripherals interface 1106 to provide data that can be used to determine the direction of magnetic North. Electronic magnetometer 1116 can provide data to an electronic compass application. Motion sensor(s) 1110 can include one or more accelerometers and/or gyros configured to determine change of speed and direction of movement. Barometer 1117 can be configured to measure atmospheric pressure. Bio signal sensor 1120 can be one or more of a PPG sensor, an electroencephalogram (EEG) sensor, an electrocardiogram (ECG) sensor, an electromyogram (EMG) sensor, a mechanomyogram (MMG) sensor (e.g., piezo resistive sensor) for measuring muscle activity/contractions, an electrooculography (EOG) sensor, a galvanic skin response (GSR) sensor, a magnetoencephalogram (MEG) sensor and/or other suitable sensor(s) configured to measure bio signals.

Communication functions can be facilitated through wireless communication subsystems 1124, which can include radio frequency (RF) receivers and transmitters (or transceivers) and/or optical (e.g., infrared) receivers and transmitters. The specific design and implementation of the communication subsystem 1124 can depend on the communication network(s) over which a mobile device is intended to operate. For example, architecture 1100 can include communication subsystems 1124 designed to operate over a GSM network, a GPRS network, an EDGE network, a Wi-Fi™ network and a Bluetooth™ network. In particular, the wireless communication subsystems 1124 can include hosting protocols, such that the mobile device can be configured as a base station for other wireless devices.

Audio subsystem 1126 can be coupled to a speaker 1128 and a microphone 30 to facilitate voice-enabled functions, such as voice recognition, voice replication, digital recording and telephony functions. Audio subsystem 1126 can be configured to receive voice commands from the user.

I/O subsystem 1140 can include touch surface controller 1142 and/or other input controller(s) 1144. Touch surface controller 1142 can be coupled to a touch surface 1146. Touch surface 1146 and touch surface controller 1142 can, for example, detect contact and movement or break thereof using any of a plurality of touch sensitivity technologies, including but not limited to capacitive, resistive, infrared and surface acoustic wave technologies, as well as other proximity sensor arrays or other elements for determining one or more points of contact with touch surface 1146. Touch surface 1146 can include, for example, a touch screen or the digital crown of a smart watch. I/O subsystem 1140 can include a haptic engine or device for providing haptic feedback (e.g., vibration) in response to commands from processor 1104. In an embodiment, touch surface 1146 can be a pressure-sensitive surface.

Other input controller(s) 1144 can be coupled to other input/control devices 1148, such as one or more buttons, rocker switches, thumb-wheel, infrared port and USB port. The one or more buttons (not shown) can include an up/down button for volume control of speaker 1128 and/or microphone 1130. Touch surface 1146 or other controllers 1144 (e.g., a button) can include, or be coupled to, fingerprint identification circuitry for use with a fingerprint authentication application to authenticate a user based on their fingerprint(s).

In one implementation, a pressing of the button for a first duration may disengage a lock of the touch surface 1146; and a pressing of the button for a second duration that is longer than the first duration may turn power to the mobile device on or off. The user may be able to customize a functionality of one or more of the buttons. The touch surface 1146 can, for example, also be used to implement virtual or soft buttons.

In some implementations, the mobile device can present recorded audio and/or video files, such as MP3, AAC and MPEG files. In some implementations, the mobile device can include the functionality of an MP3 player. Other input/output and control devices can also be used.

Memory interface 1102 can be coupled to memory 1150. Memory 1150 can include high-speed random access memory and/or non-volatile memory, such as one or more magnetic disk storage devices, one or more optical storage devices and/or flash memory (e.g., NAND, NOR). Memory 1150 can store operating system 1152, such as the iOS operating system developed by Apple Inc. of Cupertino, California. Operating system 1152 may include instructions for handling basic system services and for performing hardware dependent tasks. In some implementations, operating system 1152 can include a kernel (e.g., UNIX kernel).

Memory 1150 may also store communication instructions 1154 to facilitate communicating with one or more additional devices, one or more computers and/or one or more servers, such as, for example, instructions for implementing a software stack for wired or wireless communications with other devices. Memory 1150 may include graphical user interface instructions 1156 to facilitate graphic user interface processing; sensor processing instructions 1158 to facilitate sensor-related processing and functions; phone instructions 1160 to facilitate phone-related processes and functions; electronic messaging instructions 1162 to facilitate electronic-messaging related processes and functions; web browsing instructions 1164 to facilitate web browsing-related processes and functions; media processing instructions 1166 to facilitate media processing-related processes and functions; GNSS/Location instructions 1168 to facilitate generic GNSS and location-related processes and instructions; and gesture recognition instructions 1170 that implement the gesture recognition processes described in reference to FIGS. 1-10. Memory 1150 further includes other application instructions 1172 including but not limited to instructions for applications that respond to finger/hand gestures.

Each of the above identified instructions and applications can correspond to a set of instructions for performing one or more functions described above. These instructions need not be implemented as separate software programs, procedures, or modules. Memory 1150 can include additional instructions or fewer instructions. Furthermore, various functions of the mobile device may be implemented in hardware and/or in software, including in one or more signal processing and/or application specific integrated circuits.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As described above, some aspects of the subject matter of this specification include gathering and use of data available from various sources to improve services a mobile device can provide to a user. The present disclosure contemplates that in some instances, this gathered data may identify a particular location or an address based on device usage. Such personal information data can include location-based data, addresses, subscriber account identifiers, or other identifying information.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In the case of advertisement delivery services, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

What is claimed is:

1. A method comprising:
receiving, with at least one processor, sensor signals indicative of a hand gesture made by a user, the sensor data obtained from at least one sensor of a wearable device worn by the user;
generating, with the at least one processor, a first embedding of first features extracted from the sensor signals;
predicting, with the at least one processor, a first part of a hold gesture based on a first machine learning (ML) gesture classifier and the first embedding;
generating, with the at least one processor, a second embedding of second features extracted from the sensor signals;
predicting, with the at least one processor, a second part of the hold gesture based on a second ML gesture classifier and the second embedding;
predicting, with the at least one processor, a hold gesture based at least in part on outputs of the first and second ML gesture classifiers and a prediction policy; and
performing, with at least one processor, an action on the wearable device or other device based on the predicted hold gesture.

2. The method of claim 1, wherein the sensor signals include a bio signal and at least one motion signal.

3. The method of claim 1, wherein the first and second ML gesture classifiers are run concurrently in parallel.

4. The method of claim 1, where the prediction policy comprises:
determining, with the at least one processor, whether the first ML gesture classifier predicts the first part of the hold gesture based on a first set of prediction probabilities over a gesture time window;
determining, with the at least one processor, whether the second ML gesture classifier predicts the second part of the hold gesture based on a second set of prediction probabilities over the gesture time window;
aggregating, with the at least one processor, the first and second sets of probabilities;
determining, with the at least one processor, whether a pair of corresponding probabilities from the first and second sets of probabilities meets or exceeds a minimum threshold during the gesture time window; and
in accordance with determining that corresponding probabilities from the first and second sets of probabilities meet or exceed the minimum threshold during the gesture time window, predicting the hold gesture.

5. The method of claim 1, wherein the first and second ML gesture classifiers are convolutional neural networks.

6. The method of claim 1, wherein the sensor signals are each filtered through a number of band-pass filters having adjacent and non-overlapping frequency bands.

7. The method of claim 1, wherein the first and second ML gesture classifiers are trained by dissecting the sensor signals into N second input buffers overlapping by a prediction frequency.

8. The method of claim 1, wherein the first and second ML gesture classifiers share a common network for generating the first and second embeddings.

9. The method of claim 1, wherein the first and second ML gesture classifiers have separate networks for generating the first and second embeddings, respectively.

10. The method of claim 1, wherein generating the first and second embeddings, further comprises:
extracting, using at least one self-attention network, features from the sensor signals;
concatenating the features into a data structure;
performing multilayer convolution on contents of the data structure; and
generating the first and second embeddings based on results of the multilayer convolution.

11. A system comprising:
at least one processor;
memory storing instructions, that when executed by the at least one processor, cause the at least one process to perform operations comprising:
receiving sensor signals indicative of a hand gesture made by a user, the sensor data obtained from at least one sensor of a wearable device worn by the user;
generating a first embedding of first features extracted from the sensor signals;
predicting a first part of a hold gesture based on a first machine learning (ML) gesture classifier and the first embedding;
generating a second embedding of second features extracted from the sensor signals;
predicting, with the at least one processor, a second part of the hold gesture based on a second ML gesture classifier and the second embedding;
predicting a hold gesture based at least in part on outputs of the first and second ML gesture classifiers and a prediction policy; and
performing an action on the wearable device or other device based on the predicted hold gesture.

12. The system of claim 11, wherein the sensor signals include a bio signal and at least one motion signal.

13. The system of claim 11, wherein the first and second ML gesture classifiers are run concurrently in parallel.

14. The system of claim 11, where the prediction policy comprises:
determining, with the at least one processor, whether the first ML gesture classifier predicts the first part of the hold gesture based on a first set of prediction probabilities over a gesture time window;
determining, with the at least one processor, whether the second ML gesture classifier predicts the second part of the hold gesture based on a second set of prediction probabilities over the gesture time window;
aggregating, with the at least one processor, the first and second sets of probabilities;
determining, with the at least one processor, whether a pair of corresponding probabilities from the first and second sets of probabilities meets or exceeds a minimum threshold during the gesture time window; and
in accordance with determining that corresponding probabilities from the first and second sets of probabilities meet or exceed the minimum threshold during the gesture time window, predicting the hold gesture.

15. The system of claim 11, wherein the first and second ML gesture classifiers are convolutional neural networks.

16. The system of claim 11, wherein the sensor signals are each filtered through a number of band-pass filters having adjacent and non-overlapping frequency bands.

17. The system of claim 11, wherein the first and second ML gesture classifiers are trained by dissecting the sensor signals into N second input buffers overlapping by a prediction frequency.

18. The system of claim 11, wherein the first and second ML gesture classifiers share a common network for generating the first and second embeddings.

19. The system of claim 11, wherein the first and second ML gesture classifiers have separate networks for generating the first and second embeddings, respectively.

20. The system of claim 11, wherein generating the first and second embeddings, further comprises:
extracting, using at least one self-attention network, features from the sensor signals;
concatenating the features into a data structure;
performing multilayer convolution on contents of the data structure; and
generating the first and second embeddings based on results of the multilayer convolution.
